(19) United States
(12) Patent Application Publication
(10) Pub. No.: US 2026/0167085 A1
(43) Pub. Date: Jun. 18, 2026

(54) TIE-DOWN ANCHOR

(71) Applicant: Guangzhou Binse Network Technology Co., Ltd., Guangzhou (CN)

(72) Inventors: Shuzheng Lao, Guangzhou (CN); Hebiao Huang, Guangzhou (CN)

(21) Appl. No.: 19/318,413

(22) Filed: Sep. 4, 2025

(30) Foreign Application Priority Data
Dec. 16, 2024 (CN) 202423113549.X

(51) Int. Cl. B60P 7/08

(52) U.S. Cl. CPC B60P 7/0807

(57) ABSTRACT

A tie-down anchor includes a mounting assembly and a connecting ring. The mounting assembly is configured to be mounted on a carriage. The connecting ring is connected to the mounting assembly, swingable relative to the mounting assembly, and configured to be connected with a rope.

### CROSS REFERENCE TO RELATED APPLICATIONS

This application claims priority to the Chinese patent application No. 202423113549.X, filed on Dec. 16, 2024, the disclosure of which is incorporated by reference herein in its entirety.

### FIELD OF THE DISCLOSURE

The present disclosure relates to the field of fastening tools, in particular to a tie-down anchor.

### BACKGROUND

A truck is usually used for transporting goods. To prevent cargo from falling off a carriage, ropes are used to tighten the cargo to the carriage. Typically, a tie-down anchor is installed on the carriage and includes a protruding annular head, and a rope is connected to the protruding annular head through a rope buckle. However, for the tie-down anchor in the art, in order to allow the rope buckle to pass through, the annular head is large in size. Additionally, the annular head is configured as a fixed structure, in this way, after the rope is fixed to the carriage, a point at which the rope applies a force to the carriage is elevated, reducing a contact pressure between the rope and cargo, such that the cargo may not be secured effectively.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a tie-down anchor is provided. The tie-down anchor includes a mounting assembly and a connecting ring. The mounting assembly is configured to be mounted on a carriage. The connecting ring is connected to the mounting assembly, swingable relative to the mounting assembly, and configured to be connected with a rope.

### BRIEF DESCRIPTION OF THE DRAWINGS

Illustrative embodiments of the present disclosure are described in detail below with reference to the attached drawing figures.

FIG. 1 is a schematic view of a tie-down anchor according to some embodiments of the present disclosure.

FIG. 2 is an exploded view of the tie-down anchor according to some embodiments of the present disclosure.

FIG. 3 is a structural view of a portion of the tie-down anchor according to some embodiments of the present disclosure.

FIG. 4 is a schematic view showing movement directions of various components of the tie-down anchor according to some embodiments of the present disclosure.

FIG. 5 is a schematic view I of the tie-down anchor installed in a mounting hole of a carriage according to some embodiments of the present disclosure, where a connecting ring is connected to a rope via a rope buckle.

FIG. 6 is a schematic view II of the tie-down anchor installed in the mounting hole of the carriage according to some embodiments of the present disclosure, where a force application point F at which the rope applies a force to a mounting assembly is shown.

FIG. 7 is a schematic view of the tie-down anchor installed in the mounting hole in an unused state, according to some embodiments of the present disclosure.

Reference numerals in the drawings:
Mounting assembly 1, lock rod 11, blocking member 12, pressing member 13, drive member 14, soft fixing member 15, connecting lock head 101, connecting hole 102, fixing hook 131, helical groove 151, outer diameter D1 of connecting lock head;
Connecting ring 2, outer diameter D2 of connecting ring;
Rope 3, rope buckle 31;
Carriage 4, mounting hole 41, inner wall of mounting hole 411;
length direction of the lock rod A, direction B perpendicular to the length direction of the lock rod, force application point F.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which this disclosure belongs. The terms used in the description of the application herein are intended for describing particular embodiments only and are not intended to limit the present disclosure. In the description, claims, and the above drawings of the present disclosure, the terms “comprising” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in connection with an embodiment may be included in at least one embodiment of the present disclosure. The appearance of the phrase at various places in the specification does not necessarily refer to the same embodiment, nor is it a separate or alternative embodiment that is mutually exclusive of other embodiments. One skilled in the art would explicitly and implicitly understand that the embodiments described herein can be combined with other embodiments.

In order to enable those skilled in the art to better understand the technical solutions of the present disclosure, the technical solutions in the embodiments of the present disclosure will be clearly and completely described below with reference to the accompanying drawings.

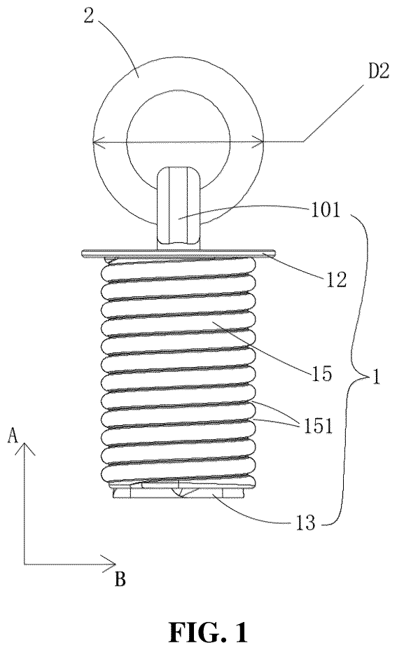

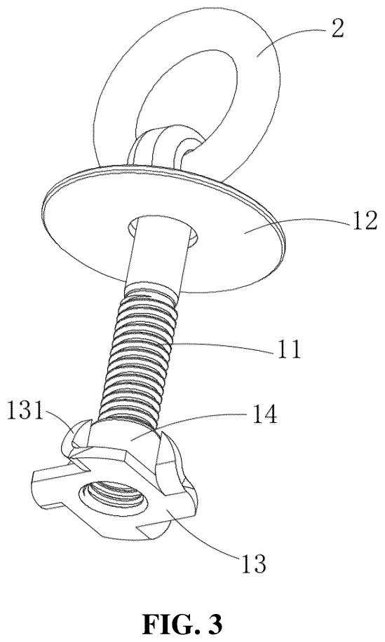

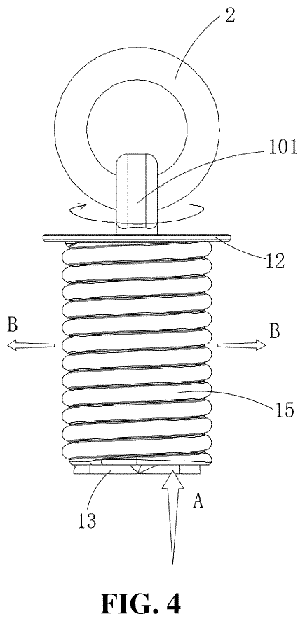

As shown in FIG. 1 to FIG. 7, the present disclosure provides a tie-down anchor, including a mounting assembly 1 and a connecting ring 2. The mounting assembly 1 may be installed on a carriage 4. A top of the mounting assembly 1 may be arranged with a connecting lock head 101 protruding out of a top surface of the carriage 4. A connecting hole 102 may be defined in and may penetrate the connecting lock head 101. The connecting lock head 101 may be substantially spherical or annular.

In some embodiments, the connecting ring 2 may be made of metal. The connecting ring 2 may pass through the connecting hole 102. That is, the connecting ring 2 may be disposed above the carriage 4. The connecting ring 2 may swing up and down around the connecting lock head 101 to connect a rope 3. Specifically, a rope buckle 31 arranged at an end of the rope 3 may pass through the connecting ring 2, meaning that the rope buckle 31 may be interlocked with the connecting ring 2.

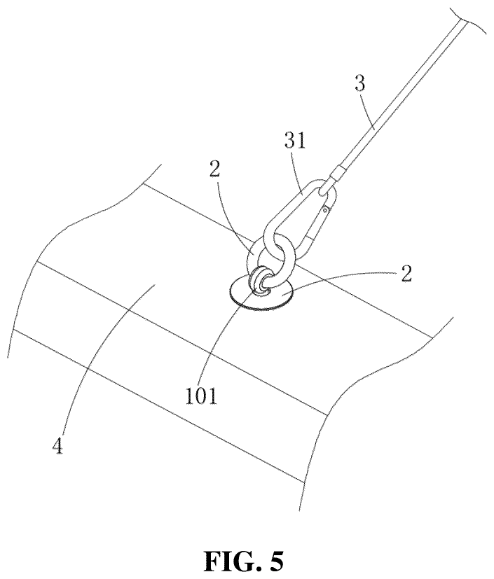

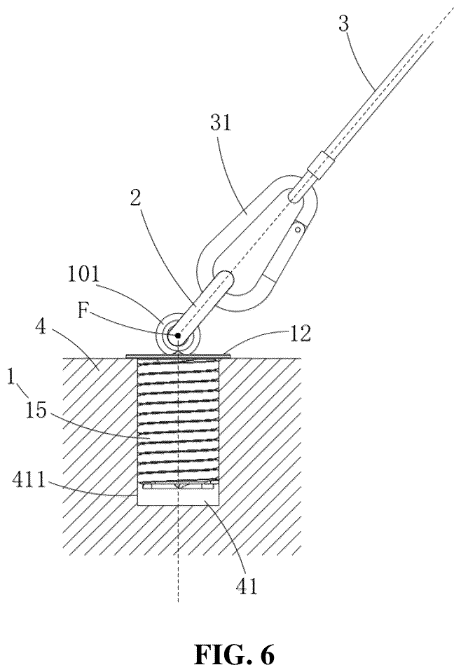

As shown in FIG. 5 and FIG. 6, since the connecting ring 2 can swing, when the rope 3 is connected to the connecting ring 2 and applies a pulling force to the connecting ring 2, the connecting ring 2 may tilt in a direction of the pulling force and may apply a force, which may have a same magnitude as the pulling force and may be in a same direction as the direction of the pulling force, to the connecting lock head 101. At this moment, the connecting ring 2 may serve as an extension of the rope 3, and it may be equivalent to the rope 3 exerting the pulling force on the connecting lock head 101. As a height of the connecting lock head 101 is lower, a force application point F at which the rope 3 applies the pulling force to the carriage 4 may be lower, thus improving closeness of a contact between the rope 3 and a cargo.

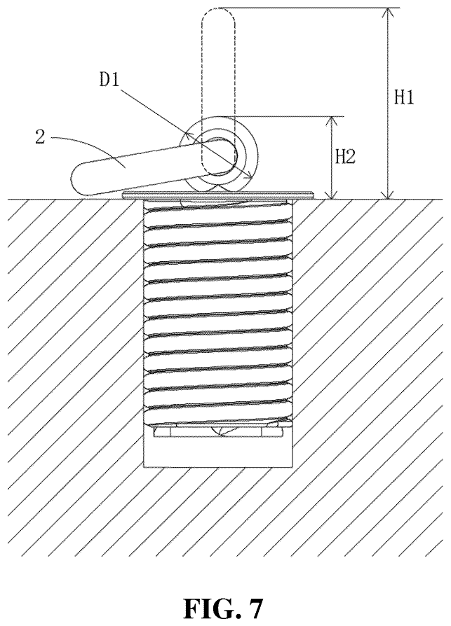

As shown in FIG. 7, when the tie-down anchor is unused, the connecting ring 2 may swing downward to be adjacent to or to abut against the carriage 4. In this way, a height H2 a highest point of the anchor may be lowered, i.e., a height in which the tie-down anchor 4 protrudes out of the top surface of the carriage 4 is lowered. Therefore, the anchor may minimize interference with normal use of the carriage 4. In FIG. 7, when the connecting ring 2 is upright, the height in which the tie-down anchor 4 protrudes out of the top surface of the carriage 4 may be H1; when the connecting ring 2 is lying down, the height in which the tie-down anchor 4 protrudes out of the top surface of the carriage 4 may be H2, and the H2 is significantly less than the H1.

In summary, since the tie-down anchor is arranged with the connecting ring 2 to connect to the rope 3, the connecting lock head 101 may be smaller in size. The connecting ring 2 may serve as the extension of the rope 3, and the force application point at which the rope 3 applies the force to the connecting lock head 101 may be lowered. On one hand, the closeness of the contact between the rope 3 and the cargo may be improved. On the other hand, the height in which the anchor protrudes out of the carriage 4 when unused may be reduced.

Further, the connecting lock head 101 may be annular, and the connecting hole 102 may be defined at a center of the connecting lock head 101. An outer diameter D1 of the connecting lock head 101 may be smaller than an outer diameter D2 of the connecting ring 2, and a ratio of the outer diameter D1 of the connecting lock head 101 to the outer diameter D2 of the connecting ring 2 may range from 1:3 to 2:3, and in some embodiments, the ratio may be 1:2. After passing through the connecting hole 102, the connecting ring 2 and connecting lock head 101 may be perpendicular to each other. In detail, the connecting ring 2 may also have a through hole. A direction in which the through hole penetrates the connecting ring 2 may be perpendicular to a direction in which the connecting hole 102 penetrates the connecting lock head 101.

Further, the mounting assembly includes a lock rod 11, a blocking member 12, a pressing member 13, a drive member 14, and a soft fixing member 15. Specifically, the connecting lock head 101 may be arranged on the lock rod 11, and the blocking member 12 may be arranged on the lock rod 11 and adjacent to the connecting lock head 101. The pressing member may sleeve an outside of the lock rod 11 and may move along a length direction A toward or away from the blocking member 12. The drive member 14 may be mounted on the pressing member 13 and may be threadedly connected to the lock rod 11. Rotation of the lock rod 11 may drive the drive member 14 to move along the length direction A of the lock rod 11 and drive the pressing member 13 to move toward or away from the blocking member 12. The soft fixing member 15 may sleeve the outside of the lock rod 11 and may be connected between the blocking member 12 and the pressing member 13. More specifically, a top end of the soft fixing member 15 may abut against the blocking member 12, and a lower end of the soft fixing member 15 may abut against the pressing member 13.

Specifically, the carriage 4 may define a mounting hole 41. When the tie-down anchor is in use, the mounting assembly 1 may be inserted into the mounting hole 41. A user may rotate the connecting ring 2 or the connecting lock head 101, enabling the lock rod 11 to rotate forward, driving the drive member 14 to move upward to further drive the pressing member 13 to move toward the blocking member 12. The compression sleeve 13 may apply an upward pressure to the soft fixing member 15. In this way, the soft fixing member 15 may be compressed in the length direction A of the lock rod 11 and may expand in a direction B perpendicular to the length direction A. That is, the soft fixing member 15 may be compressed in a vertical direction and expanded in a lateral direction. The expansion of the soft fixing member 15 in the lateral direction may cause the soft fixing member 15 to press against an inner wall 411 of the mounting hole 41, increasing friction between the soft fixing member 15 and the inner wall 411 of the mounting hole 41 to prevent the mounting assembly 1 from dislodging off from the mounting hole 41.

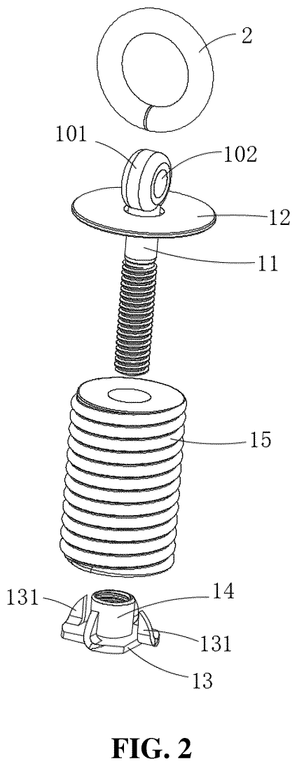

In an embodiment, as shown in FIG. 2, the blocking member 12 may be plate-shaped and may sleeve an upper portion of the lock rod 11. A lower portion of the lock rod 11 may be provided with external threads. The drive member 14 may be arranged with internal threads and may be threadedly connected to the lower portion of the lock rod 11. The pressing member 13 and drive member 14 may be integrally formed as a one-piece structure. When the lock rod 11 rotates, the pressing member 13 may move along the lock rod 11.

Further, the pressing member may be arranged with at least one fixing hook 131 protruding toward the soft fixing member 15 and capable of being inserted into the soft fixing member 15. As the pressing member 13 moves upward and presses the soft fixing member 15, the at least one fixing hook 131 may be embedded into the soft fixing member 15, preventing the pressing member 13 and the drive member 14 from rotating with respect to the soft fixing member 15. That is, during rotation of the lock rod 11, the drive member 14 may not rotate synchronously, and therefore, a driving effect of the drive member 14 may not fail.

Specifically, the at least one fixing hook 131 may be four fixing hooks 131. The four fixing hooks 131 may be arranged circumferentially about the lock rod 11 to enhance fixation between the pressing member 13 and the soft fixing member 15.

To improve the friction between the soft fixing member 15 and the inner wall 411 of the mounting hole 41, the soft fixing member 15 may be made of rubber. An outer wall of the soft fixing member 15 may define helical grooves 151. Under normal conditions, the outer diameter of the soft fixing member 15 may be larger than an inner diameter of the mounting hole 41. When the mounting assembly 1 is pressed into the mounting hole 41, the mounting assembly 1 may be rotated and pressed downward to enable the soft fixing member 15 to be inserted into the mounting hole 41. In this way, the soft fixing member may remain compressing against the inner wall 411 of the mounting hole 41. Upward movement of the pressing member 13 may only increase a compression force applied by the soft fixing member 15 to the inner wall 411 of the mounting hole 41. As the compression force increases, the friction between the soft fixing member 15 and the inner wall 411 of the mounting hole 41 is increased.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

What is claimed is:

1. A tie-down anchor, comprising:
a mounting assembly, configured to be mounted on a carriage; and
a connecting ring, connected to the mounting assembly, swingable relative to the mounting assembly, and configured to be connected with a rope.

2. The tie-down anchor according to claim 1, wherein the mounting assembly comprises a connecting lock head, and the connecting lock head is arranged at a top end of the mounting assembly and defines a connecting hole which is through-going; the connecting ring passes through the connecting hole and is swingable up and down relative to the connecting lock head.

3. The tie-down anchor according to claim 2, wherein the connecting lock head is arranged in a ring shape, and the connecting hole is formed at a center of the connecting lock head.

4. The tie-down anchor according to claim 3, wherein an outer diameter of the connecting ring is greater than an outer diameter of the connecting lock head.

5. The tie-down anchor according to claim 2, wherein the mounting assembly comprises:
a lock rod, wherein the connecting lock head is arranged on the lock rod;
a blocking member, mounted on the lock rod and arranged close to the connecting lock head;
a pressing member, sleeving a periphery of the lock rod;
a drive member, mounted on the pressing member, and threadedly connected to the lock rod, wherein the lock rod is configured to rotate to drive the drive member to move along a length direction of the lock rod and drive the pressing member to move towards or away from the blocking member; and
a soft fixing member, sleeving the periphery of the lock rod and connected with the blocking member and the pressing member;
when the pressing member moves towards the blocking member, the soft fixing member is compressed in the length direction of the lock rod and expands in a direction perpendicular to the length direction of the lock rod.

6. The tie-down anchor according to claim 5, wherein the pressing member and the drive member are integrally formed as a one-piece structure, and when the pressing member rotates relative to the lock rod, the pressing member moves along the lock rod.

7. The tie-down anchor according to claim 5, wherein the pressing member is arranged with at least one fixing hook, and the at least one fixing hook protrudes towards the soft fixing member, and the fixing hook is insertable in the soft fixing member.

8. The tie-down anchor according to claim 5, wherein the blocking member sleeves the periphery of the lock rod and is configured to abut against the connecting lock head.

9. The tie-down anchor according to claim 5, wherein an outer wall of the soft fixing member defines a helical groove.

10. The tie-down anchor according to claim 5, wherein the soft fixing member is made of a rubber material.
